(19) United States
(12) Patent Application Publication
(10) Pub. No.: US 2013/0079065 A1
(43) Pub. Date: Mar. 28, 2013

(54) MULTI-MODE POWER AMPLIFIER

(71) Applicants: Byeong Hak Jo, Suwon (KR); Hyeon Seok Hwang, Seoul (KR); Yoo Sam Na, Seoul (KR); Yoo Hwan Kim, Yongin (KR)

(72) Inventors: Byeong Hak Jo, Suwon (KR); Hyeon Seok Hwang, Seoul (KR); Yoo Sam Na, Seoul (KR); Yoo Hwan Kim, Yongin (KR)

(21) Appl. No.: 13/620,685

(22) Filed: Sep. 14, 2012

(30) Foreign Application Priority Data
Sep. 23, 2011 (KR) 10-2011-0096168

(51) Int. Cl. H04W 52/02

(52) U.S. Cl. 455/571

(57) ABSTRACT

There is provided a multi-mode power amplifier having increased isolation, including: a high power mode amplifying unit amplifying an input signal by a pre-set gain when the input signal has a power level higher than a pre-set reference level; a low power mode amplifying unit amplifying the input signal by a pre-set gain when the input signal has a power level lower than the pre-set reference level; a switch unit including one or more switches selectively proving a signal transmission path to the high power mode amplifying unit and the low power mode amplifying unit; and a controller providing a control signal having a pre-set voltage level for switching the one or more switches of the switch unit on or off, the voltage level of the control signal for switching the one or more switches off being set to be a negative voltage.

### CROSS-REFERENCE TO RELATED APPLICATIONS

This application claims the priority of Korean Patent Application No. 10-2011-0096168 filed on Sep. 23, 2011, in the Korean Intellectual Property Office, the disclosure of which is incorporated herein by reference.

### BACKGROUND OF THE INVENTION

1. Field of the Invention

The present invention relates to a multi-mode power amplifier having improved isolation.

2. Description of the Related Art

Recently, the use of wireless communication terminals has increased due to strengths thereof in that they are easy to use and are lightweight.

Effective wireless mobile terminal power use is crucial, and since a component with regard to power amplification in wireless communication terminals consumes a relatively large amount of power, power amplifier power efficiency is necessarily increased to enhance an overall call time.

Wireless communication terminal output power is controlled according to the distance between the wireless communication terminal and a repeater, so with reference to a probability density function based on wireless communication terminal output power, efficiency enhancement at low output power, backed-off from a maximum power output by 10 dB or greater, directly affects call time enhancement. Namely, power efficiency in a low power mode having a low power level, as well as in a high power mode, i.e., a maximum power output, needs to be increased.

Thus, the necessity of a multi-mode power amplifier performing a different power amplification operation in a low power mode and a high power mode has been on the rise.

However, the multi-mode power amplifier uses a switch for selecting a signal transmission path in the low power mode or the high power mode, and here, isolation according to the use of the switch may be degraded.

### SUMMARY OF THE INVENTION

An aspect of the present invention provides a multi-mode power amplifier in which an OFF switching signal, having a negative voltage level, is provided to a switch that switches a signal transmission path and negative power is provided to a switch body according to a low power mode or high power mode to increase isolation of respective power modes, and when each amplifier is turned off, an OFF switching signal is provided as bias power to thus further increase isolation of the power modes.

According to an aspect of the present invention, there is provided a multi-mode power amplifier including: a high power mode amplifying unit amplifying an input signal by a pre-set gain when the input signal has a power level higher than a pre-set reference level; a low power mode amplifying unit amplifying the input signal by the pre-set gain when the input signal has a power level lower than the pre-set reference level; a switch unit including one or more switches selectively proving a signal transmission path to the high power mode amplifying unit and the low power mode amplifying unit; and a controller providing a control signal having a pre-set voltage level for switching the one or more switches of the switch unit on or off, the voltage level of the control signal for switching the one or more switches off being set to be a negative voltage.

The controller may further provide a control signal having a negative voltage level to a body of the one or more switches.

The high power mode amplifying unit may include: a driving amplifier amplifying the input signal by the pre-set gain; a first converter converting a single signal from the driving amplifier into a balance signal; a power amplifier re-amplifying the balance signal from the first converter by the pre-set gain; and a second converter converting the balance signal from the power amplifier into a single signal and outputting the converted single signal.

The high power mode amplifying unit may further include: a first selection supplier supplying pre-set bias power to the driving amplifier when the control signal from the controller is an ON switching signal, and supplying a voltage level of the OFF switching signal, as bias power, to the driving amplifier when the control signal from the controller is the OFF switching signal; and a second selection supplier supplying the pre-set bias power to the power amplifier when the control signal from the controller is an ON switching signal, and supplying a voltage level of the OFF switching signal, as bias power, to the power amplifier when the control signal from the controller is the OFF switching signal.

The low power mode amplifying unit may include: a low power amplifier amplifying the input signal by the pre-set gain; and a matching device matching the impedance between an output terminal of the low power amplifier and a final output terminal.

The low power mode amplifying unit may further include: a third selection supplier supplying pre-set bias power to the low power amplifier when the control signal from the controller is an ON switching signal, and supplying a voltage level of the OFF switching signal, as bias power, to the low power amplifier when the control signal from the controller is the OFF switching signal.

Each of the first to third selection suppliers may include: a bias bank providing bias power having a voltage level according to a power level of the input signal; and a multiplexer selectively supplying the bias power of the bias bank and the voltage level of the control signal.

The controller may include: a voltage controlled oscillator (VCO) providing reference power having a pre-set voltage level; a charge pump shifting a voltage level of the reference power from the VCO to provide the negative voltage; and a level shifter shifting the voltage level of the reference power according to a selection signal for selecting a low power or a high power amplification mode to provide a control signal.

The switch unit may include: a first switch switching a signal transmission path between the input signal and the high power amplifying unit; a second switch switching a signal transmission path between the input signal and the low power amplifying unit; and a third switch selecting a signal transmission path of an output signal of the high power amplifying unit and an output signal of the low power amplifying unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a multi-mode power amplifier according to an embodiment of the present invention;

FIG. 2 is a view showing the configuration of a switch employed in the multi-mode power amplifier according to an embodiment of the present invention;

FIG. 3 is a view showing the configuration of a controller employed in the multi-mode power amplifier according to an embodiment of the present invention;

FIG. 4 is a view showing the configuration of first to third selection suppliers employed in the multi-mode power amplifier according to an embodiment of the present invention;

FIG. 5 is a view showing the configuration of an amplifier employed in the multi-mode power amplifier according to an embodiment of the present invention; and

FIG. 6 is a graph showing enhanced isolation of the multi-mode power amplifier according to an embodiment of the present invention.

### DETAILED DESCRIPTION OF THE INVENTION

Embodiments of the present invention will now be described in detail with reference to the accompanying drawings such that they could be easily practiced by those having skill in the art to which the present invention pertains. However, in describing the embodiments of the present invention, detailed descriptions of well-known functions or constructions will be omitted so as not to obscure the description of the present invention with unnecessary detail.

In addition, like reference numerals denote like elements throughout the drawings.

Embodiments of the present invention will now be described in detail with reference to the accompanying drawings.

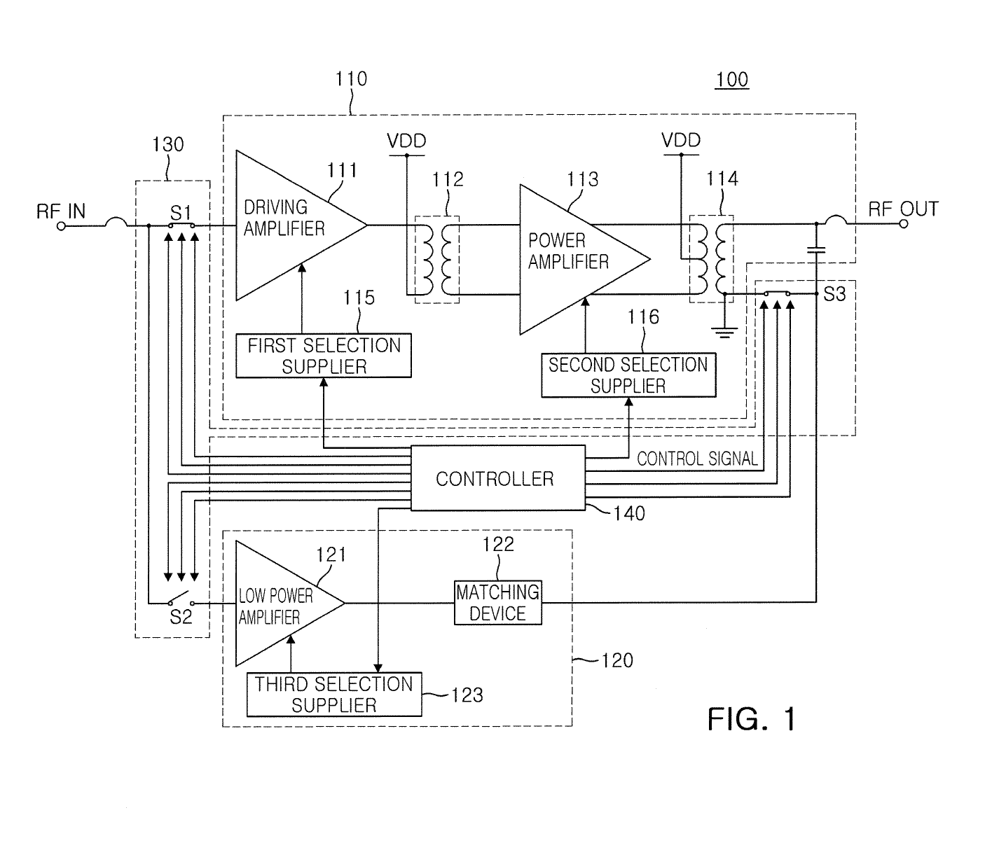

FIG. 1 is a schematic block diagram of a multi-mode power amplifier according to an embodiment of the present invention.

With reference to FIG. 1, a multi-mode power amplifier 100 may include a high power amplifying unit 110, a low power amplifying unit 120, a switch unit 130, and a controller 140.

When a power level of an input signal is a high power signal having a pre-set reference signal level or higher, the high power amplifying unit 110 may amplify the input signal by a pre-set gain according to a mode selection signal.

To this end, the high power amplifying unit 110 may include a driving amplifier 111, a first converter 112, a power amplifier 113, a second converter 114, and first and second selection suppliers 115 and 116.

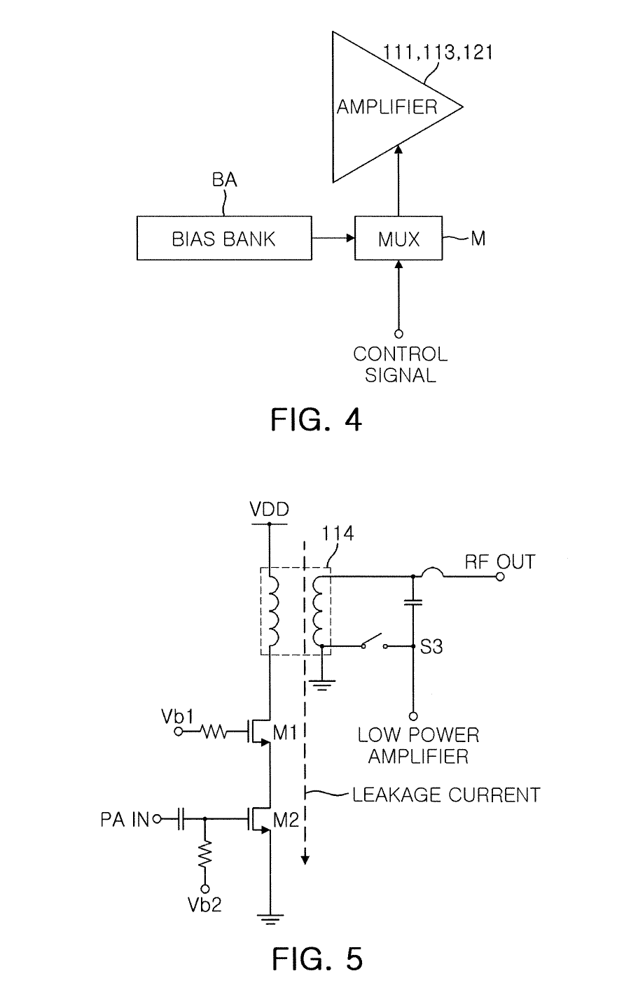

The driving amplifier 111 may amplify the signal level of the input signal by a pre-set gain. The amplified signal may be a single signal. The first converter 112 may convert the single signal from the driving amplifier 111 into a balance signal. The power amplifier 113 may re-amplify the balance signal from the first converter 112 by a pre-set gain. The second converter 114 may convert the balance signal from the power amplifier 113 into a single signal and finally output the converted single signal. The first and second selection suppliers 115 and 116 may selectively supply bias power or a voltage level of the control signal from the controller 140 to the driving amplifier 111 or the power amplifier 113 according to a mode selection. This will be described in detail with reference to FIG. 4.

When the input signal is a low power signal having a power level equal to or lower than a pre-set reference signal, the low power amplifying unit 120 may amplify the input signal by a pre-set gain according to a mode selection signal. To this end, the low power amplifying unit 120 may include a low power amplifier 121, a matching device 122, and a third selection supplier 123.

The low power amplifier 121 may amplify the signal level of the input signal by a pre-set gain. The amplified signal may be a single signal. In a case in which an output terminal of the high power amplifying unit 110 and a final output terminal have already been impedance-matched, the impedance matching, which has been already made, may be mismatched when the low power amplifying unit 120 operates. The matching device 122 may perform impedance matching between an output terminal of the low power amplifier 121 and the final output terminal to allow for smooth impedance matching at the output terminals in a high power mode or a low power mode in the multi-mode power amplifier 100.

The third selection supplier 123 may selectively supply bias power or a voltage level of a control signal from the controller 140 to the low power amplifier 121 according to a mode selection. This will be described in detail along with the foregoing first and second selection suppliers 115 and 116 with reference to FIG. 4.

The switch unit 130 may selectively provide a signal transmission path to the high power mode amplifying unit 110 or the low power mode amplifying unit 120. To this end, the switch unit 130 may include first, second, and third switches S1, S2, and S3.

The first switch S1 may be connected between an input signal terminal to which the input signal is transferred and the high power mode amplifying unit 110. The second switch S2 may be connected between the input signal terminal and the low power mode amplifying unit 120. The third switch S3 may be connected between the high power mode amplifying unit 110, the low power mode amplifying unit 120 and the final output terminal.

The first, second, third switches S1, S2, and S3 may switch a signal transmission path upon receiving a control signal from the controller 140. Namely, when the high power mode is selected, the first and third switches S1 and S3 are switched on and the second switch S2 is switched off to allow the input signal RF IN to be transferred to the high power amplifying unit 110, so the high power amplifying unit 110 outputs an output signal RF OUT through the final output terminal. Meanwhile, when the low power mode is selected, the first and third switches S1 and S3 are switched off and the second switch S2 is switched on to allow the input signal RF IN to be transferred to the low power amplifying unit 120, so the low power amplifying unit 120 outputs an output signal RF OUT through the final output terminal.

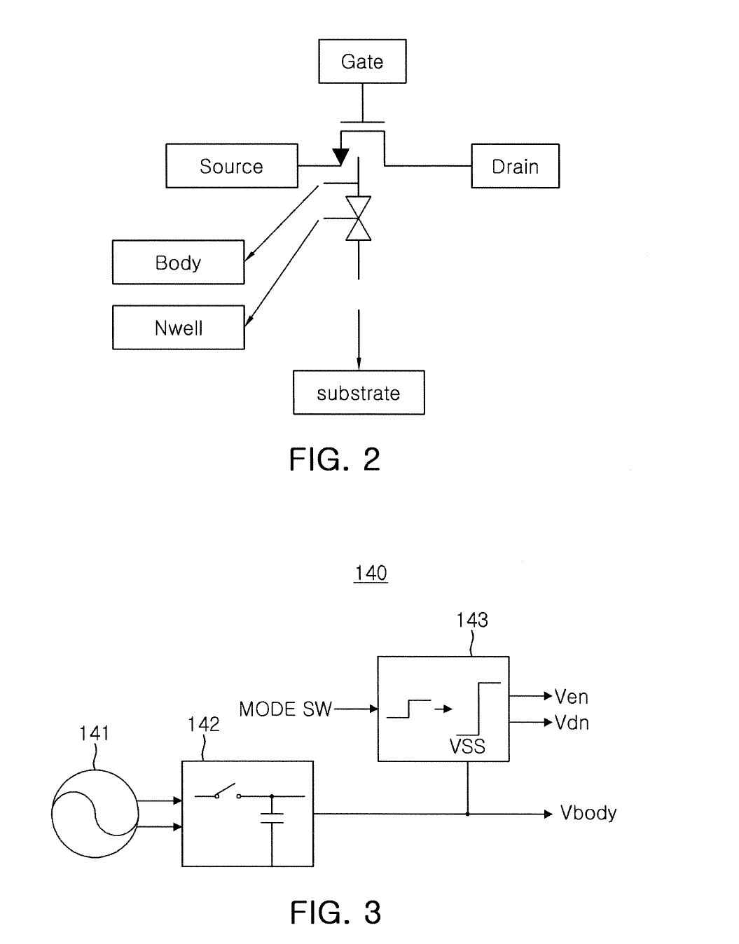

FIG. 2 is a view showing the configuration of a switch employed in the multi-mode power amplifier according to an embodiment of the present invention.

With reference to FIG. 2, the switch employed in the multi-mode power amplifier may be an N metal oxide semiconductor (MOS) type transistor or a field effect transistor (FET) having a gate, a source, and a drain, or an N MOS type transistor or an FET having a deep N well structure. Since the N MOS type transistor or FET having a deep N well structure additionally includes an N well, a diode layer can be additionally provided between a signal line between a source and a drain and a substrate, and accordingly, the N MOS type transistor or FET is able to switch a relatively greater signal.

Meanwhile, the controller 140 may provide a control signal controlling an ON switching or an OFF switching operation, to the first to third switches S1, S2, and S3. In the case of the ON switching operation, the control signal may have a pre-set positive voltage level, and in the case of the OFF switching operation, the control signal may have a pre-set negative voltage level. For example, in the case of the ON switching operation, the controller 140 may provide a control signal having a voltage level of about 3.3V, and in the case of the OFF switching operation, the controller 140 may provide a control signal having a voltage level of about −3.3V. In addition, the controller 140 may further provide a control signal having a negative voltage level to the bodies of the first to third switches S1, S2, and S3, and the voltage level of the control signal applied to the bodies of the switches may be set to be −3.3V, which is equal to the voltage level for the OFF switching operation.

Namely, the OFF switching voltage of the switches and the body voltage have a negative voltage level, thereby improving the isolation characteristics between the high power mode and the low power mode.

FIG. 3 is a view showing the configuration of the controller employed in the multi-mode power amplifier according to an embodiment of the present invention.

With reference to FIG. 3, the controller 140 employed in the multi-mode power amplifier may include a voltage control oscillator 141, a charge pump 142, and a level shifter 143.

The voltage control oscillator 141 may provide reference power having a pre-set voltage level. The charge pump 142 MAY shift the level of the reference power to generate power having the negative voltage level. The level shifter 143 may shift the level of the negative power of the charge pump 142 according to a mode selection signal MODE SW to provide control signals Ven and Vdn for controlling an ON switching or switching OFF operation. Here, the control signal Ven is a pre-set high level signal when the high power mode is selected, and may have a low level signal set to have a lower level than that of the high level signal when the low power mode is selected, and in this case, the low level signal may be set to have a negative voltage level. Meanwhile, the control signal Vdn is a pre-set high level signal when the low power mode is selected, and may have a low level signal set to have a lower level than that of the high level signal when the high power mode is selected, and in this case, the low level signal may be set to have a negative voltage level.

FIG. 4 is a view showing the configuration of first to third selection suppliers employed in the multi-mode power amplifier according to an embodiment of the present invention.

With reference to FIGS. 1 and 4, the first to third selection suppliers employed in the multi-mode power amplifier may include a bias bank BA and a multiplexer M, respectively.

The bias bank BA may provide bias power having a voltage level set according to a power level of an input signal to the respective amplifiers 111, 113, and 121, and the multiplexer M may selectively provide a voltage level of a control signal and the bias power to the respective amplifiers 111, 113, and 121. For example, when the control signal is a signal for operating the high power mode, a control signal corresponding to an ON switching operation is transferred to the first and third switches S1 and S3, and a control signal corresponding to an OFF switching operation is transferred to the second switch S2. Accordingly, the multiplexer M of each of the first and second selection suppliers 115 and 116 may provide the bias power from the bias bank BA to the driving amplifier 111 or the power amplifier 113, and the multiplexer M of the third selection supplier 123 may provide a negative voltage of the control signal corresponding to the OFF switching operation, as bias power to the low power amplifier 121. Meanwhile, when the control signal is a signal for operating the low power mode, a control signal corresponding to the OFF switching operation is transferred to the first and third switches S1 and S3, and a control signal corresponding to an ON switching operation is transferred to the second switch S2. Accordingly, the mutliplexers M of the first and second selection suppliers 115 and 116 may provide the negative voltage of the control signal corresponding to the OFF switching operation, as bias power to the driving amplifier 111 or the power amplifier 113, and the multiplexer M of the third selection supplier 123 may provide the bias power from the bias bank BA to the low power amplifier 121.

FIG. 5 is a view showing the configuration of an amplifier employed in the multi-mode power amplifier according to an embodiment of the present invention.

With reference to FIGS. 1 and 5, the driving amplifier 111, the power amplifier 113, and the low power amplifier 121 employed in the multi-mode power amplifier may have a relatively large transistor used for amplification, so even in a case in which 0V is applied as a voltage of a gate of each of the transistors, a leakage current may be generated to reduce power efficiency. In this case, the transistors of the amplifiers may be definitely turned off by applying the negative voltage as bias power applied to the gates thereof, to thereby increase the power efficiency.

FIG. 5 shows the configuration of a power amplifier among amplifies employed in the multi-mode power amplifier according to the embodiment of the present invention.

With reference to FIGS. 1 and 5, the power amplifier 113 may have a differential structure, and only one side of the differential structure is illustrated. When the power amplifier operates in the low power mode, the third switch S3 may be switched off and an output signal of the low power amplifying unit 120 may be output to the final output terminal, and at this time, the high power amplifying unit 110, a different signal path, does not operate (i.e., in an OFF operational state). For example, when voltage levels Vb1 and Vb2 of the gate are 0V, the transistors M1 and M2 of the power amplifier 113 may be turned off, and in this case, a signal may be generated to be induced through the converter 114, failing to completely turn off the transistors M1 and M2, causing a leakage current to reduce power efficiency. The leakage current may be increased as the level of the induced signal is higher. Here, in the multi-mode power amplifier 100 according to an embodiment of the present invention, when a negative voltage is applied as a gate voltage of the transistors M1 and M2 of the power amplifier 113, isolation may be increased when the transistors M1 and M2 are turned off, and thus, although the output of the signal in the low power mode is relatively great, a leakage current may be reduced.

As described above, in the multi-mode power amplifier 100, isolation may be increased by applying the negative voltage to the body of the switch and in switching off the switch.

Table 1 below shows the comparison between the foregoing case and the case in which 0V is applied to the body of the switch and in switching off the switch.

TABLE 1

| | | In case of 870 MHz | | | In case of 1950 MHz | | |
|---|---|---|---|---|---|---|---|
| | | | | Dif- | | | Dif- |
| | | | | fer- | | | fer- |
| | | 0 V | −2.3 V | ence | 0 V | −2.3 V | ence |
| First and | Loss | −0.64 | −0.58 | 0.06 | −1.4 | −1.17 | 0.23 |
| second | Isola- | −16.99 | −19.24 | 2.25 | −10.63 | −12.69 | 2.06 |
| switches | tion | | | | | | |
| Third | Loss | −0.62 | −0.58 | 0.04 | −1.15 | −1.1 | 0.05 |
| switch | Isola- | −15.5 | −24 | 4.5 | −14.5 | −24 | 5.5 |
| | tion | | | | | | |

Here, −2.3V was set as a negative voltage, and as shown in Table 1, it is noted that difference in isolation ranges from 2.06 to 5.5

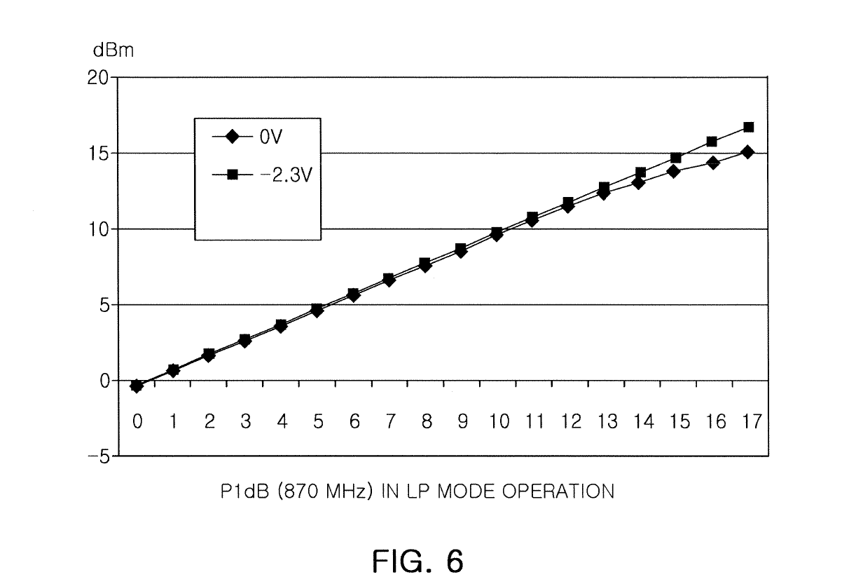

The foregoing difference will now be described in detail with reference to a graph of FIG. 6.

FIG. 6 is a graph showing enhanced isolation of the multi-mode power amplifier according to an embodiment of the present invention.

With reference to FIG. 6, when 0V is applied to the body of the switch and in switching off the switch, P1 dB is generated at 15 dBm or lower in the low power mode operation, and this does not satisfy the performance required in the low power mode, so the size of the switch must be increased to secure isolation. However, in the multi-mode power amplifier 100 according to an embodiment of the present invention, since the negative voltage is applied to the body of the switch and in switching off the switch, P1 dB may be enhanced to be 17 dBm or higher as noted. Thus, sufficient isolation may be secured for the same size of switch.

As set forth above, according to embodiments of the invention, an OFF switching signal having a negative voltage level may be provided to the switch that switches a signal transmission path and negative power is provided to a switch body according to the low power mode or the high power mode, thus increasing isolation between power modes. In addition, the OFF switching signal is provided as bias power when each amplifier is in an OFF state to reduce a leakage current and thereby increase isolation between the power modes, thus increasing power efficiency.

While the present invention has been shown and described in connection with the embodiments, it will be apparent to those skilled in the art that modifications and variations can be made without departing from the spirit and scope of the invention as defined by the appended claims.

What is claimed is:

1. A multi-mode power amplifier comprising:
a high power mode amplifying unit amplifying an input signal by a pre-set gain when the input signal has a power level higher than a pre-set reference level;
a low power mode amplifying unit amplifying the input signal by the pre-set gain when the input signal has a power level lower than the pre-set reference level;
a switch unit including one or more switches selectively proving a signal transmission path to the high power mode amplifying unit and the low power mode amplifying unit; and
a controller providing a control signal having a pre-set voltage level for switching the one or more switches of the switch unit on or off, the voltage level of the control signal for switching the one or more switches off being set to be a negative voltage.

2. The multi-mode power amplifier of claim 1, wherein the controller further provides a control signal having a negative voltage level to a body of the one or more switches.

3. The multi-mode power amplifier of claim 1, wherein the high power mode amplifying unit includes:
a driving amplifier amplifying the input signal by the pre-set gain;
a first converter converting a single signal from the driving amplifier into a balance signal;
a power amplifier re-amplifying the balance signal from the first converter by the pre-set gain; and
a second converter converting the balance signal from the power amplifier into a single signal and outputting the converted single signal.

4. The multi-mode power amplifier of claim 3, wherein the high power mode amplifying unit further includes:
a first selection supplier supplying pre-set bias power to the driving amplifier when the control signal from the controller is an ON switching signal, and supplying a voltage level of the OFF switching signal, as bias power, to the driving amplifier when the control signal from the controller is the OFF switching signal; and
a second selection supplier supplying the pre-set bias power to the power amplifier when the control signal from the controller is an ON switching signal, and supplying a voltage level of the OFF switching signal, as bias power, to the power amplifier when the control signal from the controller is the OFF switching signal.

5. The multi-mode power amplifier of claim 4, wherein the low power mode amplifying unit includes:
a low power amplifier amplifying the input signal by the pre-set gain; and
a matching device matching the impedance between an output terminal of the low power amplifier and a final output terminal.

6. The multi-mode power amplifier of claim 5, wherein the low power mode amplifying unit further includes a third selection supplier supplying pre-set bias power to the low power amplifier when the control signal from the controller is an ON switching signal, and supplying a voltage level of the OFF switching signal, as bias power, to the low power amplifier when the control signal from the controller is the OFF switching signal.

7. The multi-mode power amplifier of claim 6, wherein each of the first to third selection suppliers includes:
a bias bank providing bias power having a voltage level according to a power level of the input signal; and
a multiplexer selectively supplying the bias power of the bias bank and the voltage level of the control signal.

8. The multi-mode power amplifier of claim 1, wherein the controller includes:
a voltage controlled oscillator (VCO) providing reference power having a pre-set voltage level;
a charge pump shifting a voltage level of the reference power from the VCO to provide the negative voltage; and
a level shifter shifting the voltage level of the reference power according to a selection signal for selecting a low power or a high power amplification mode to provide a control signal.

9. The multi-mode power amplifier of claim 1, wherein the switch unit includes:
a first switch switching a signal transmission path between the input signal and the high power amplifying unit;
a second switch switching a signal transmission path between the input signal and the low power amplifying unit; and
a third switch selecting a signal transmission path of an output signal of the high power amplifying unit and an output signal of the low power amplifying unit.
